(19) United States
(12) Patent Application Publication
(10) Pub. No.: US 2006/0098548 A1
(43) Pub. Date: May 11, 2006

(54) Low power dissipation information recording apparatus

(75) Inventors: Bart Michiel De Boer, Eindhoven (FR); Johannes Aldegonda Theodora Maria Van Den Homberg, Eindhoven (NL); Albert Hendrik Jan Immink, Eindhoven (NL); Bart Van Rompaey, Eindhoven (NL); Jan Matthijs Ter Meulen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/540,696

(22) PCT Filed: Dec. 17, 2003
(86) PCT No.: PCT/IB03/06052

§ 371 Date: Jun. 24, 2005

(30) Foreign Application Priority Data
Dec. 30, 2002 (EP) 02293267.7

(51) Int. Cl. G11B 5/09

(52) U.S. Cl. 369/59.11

(57) ABSTRACT

The invention relates to an information recording apparatus intended to record information on an optical medium by forming series of recorded marks whose length between leading edge and trailing edge corresponds to a binary value by irradiation means with a beam of light. According to the invention, said irradiation means are sequentially pulsed to at least a high laser current write level from a low laser current level LL close to zero during the writing of a recorded mark. The invention enables to lower the average laser current during writing and also erasing. As a consequence the power dissipation is lowered. Application: Information recording apparatus, especially for SFFO, BluRay standards.

### FIELD OF THE INVENTION

The invention relates to an information recording apparatus intended to record information on an optical medium by forming series of recorded marks whose length between leading edge and trailing edge corresponds to a binary value by irradiation means with a beam of light. The invention also relates to an information recording method.

### BACKGROUND OF THE INVENTION

Such an information recording apparatus is known from U.S. Pat. No. 6,426,930. This document presents, for example, in the description of the prior art, an apparatus and a method of recording information on an optical medium by forming series of recorded marks whose length between leading edge and trailing edge corresponds to a binary value. This prior art describes a conventional write strategy for optical discs. FIG. 1 represents the prior art in said document. FIG. 1 depicts the writing of three successive marks MK2, MK3, MK4 on a track TRK of an optical disc, each mark representing an information B of two B2, three B3, and four bits B4 in time T. According to this conventional strategy, the writing of a continuous mark of N bits requires a conventional pulse pattern of N-1 pulses having different intensities and different durations. Said pulses of at least one high laser current write level HWL are generated from a bias level BL close to a threshold level TL. Said threshold level TL is defined by the threshold current that creates necessary population inversion. This population inversion is a minimal condition to obtain a coherent light emission. This is illustrated in FIG. 2. This latter figure depicts the light power emitted by the laser LP as a function of the laser current LC. The laser current LC consists of two parts: a relatively large threshold current TC that is not related to the light power LP being emitted, but is needed to create the population inversion, and a delta current DC that is proportional to the light power LP being emitted by the laser diode.

According to the conventional strategy presented in FIG. 1, the laser current averaged over time is high because this laser current LC is always above the threshold level TL. Consequently, a major power dissipation occurs in the laser diode during the writing of an optical disc. It is to be noted that, in N strategy, pulses are raised from a bias level, and all along a pulse the laser current is maintained at a high level, generating a high power dissipation.

### SUMMARY OF THE INVENTION

It is an object of the present invention to propose a new writing strategy and a new apparatus for recording information on an optical disc while keeping the power dissipation low.

To this end, the invention proposes an information recording apparatus as presented in the introductory part, characterized in that said irradiation means are sequentially pulsed to at least a high laser current write level from a low laser current level close to zero during the writing of a recorded mark. Said irradiation means are generally pulsed at a writing frequency that can be constant.

The invention then renders it possible to reduce the average laser current by the presence of said low level close to zero or equal to zero to which the laser is periodically switched. The average light power being emitted during writing by the laser diode can effectively remain the same while the average laser current is reduced. The invention is only restricted by the switching speed of the laser diode and of the laser driver.

The reduction of the power dissipation resulting from the invention is particularly advantageous for newly developed solutions for portable applications in which the storage capacity has to be high in combination with very small dimensions and for which the power dissipation has to be kept low. For example, small form factor optical (SFFO) disc systems would particularly benefit from the invention.

Another problem in the prior art is that the laser diode is supplied with a current that defines a high laser current erase level HEL rising above the bias level BL during erasing, see FIG. 1. It is also to be noted that the high laser current erase level HEL is another source of the rise of the average laser current in conventional strategy, even if the high laser current erase level HEL is lower to the high laser current write level HWL.

According to an advantageous embodiment of the invention, an apparatus of the invention is characterized in that the irradiation means are pulsed to a high laser current erase level from said low level during erasing of a recorded mark. Generally, said irradiation means are pulsed at an erasing frequency that can be advantageously constant.

According to a preferred embodiment of the invention, the bias level is equal to said low level LL.

The invention also relates to an information recording method that is advantageously implemented in an apparatus of the invention.

### BRIEF DESCRIPTION OF THE DRAWINGS

The invention will be described in detail below with reference to the diagrammatic Figures, wherein:

FIG. 1 presents a conventional writing strategy according to the state of the art;

FIG. 2 depicts the laser light power as function of laser current;

FIG. 3 illustrates a writing strategy according to an embodiment of the invention;

FIG. 4 illustrates a function by which a conventional pulse pattern is multiplied according to the invention;

FIG. 5 illustrates a writing strategy according to an advantageous embodiment of the invention;

FIG. 6 illustrates a writing strategy according to a preferred embodiment of the invention;

FIG. 7 is a schematic diagram of an apparatus according to the invention.

### DESCRIPTION OF EMBODIMENTS

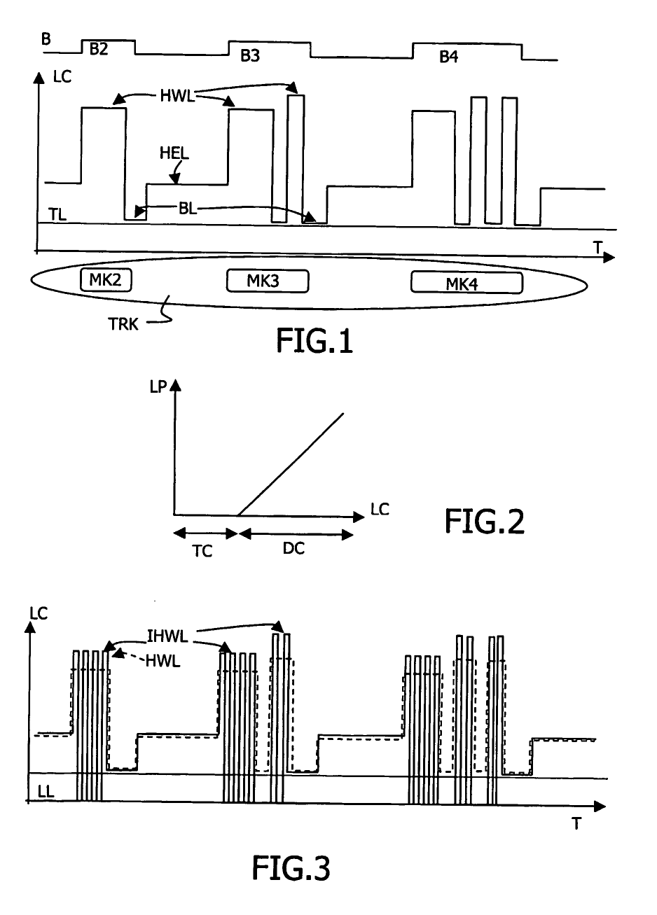

FIGS. 1 and 2 were described above in the description of the prior art. The first pulse pattern shown in FIG. 1 corresponds to a known technical constraint and will be denoted conventional pulse pattern in the following. This conventional pulse pattern is constituted of N-1 pulses for a mark of N bits. Indeed marks are of a minimum of two bits according to the classically used coding (17-PP coding) or of three bits (EFM, EFM+) on an optical medium. The N-1 strategy is used for the description of the invention; nevertheless the invention relates to any writing strategy, including N strategy. Said coding is realized before writing on said optical medium, which is generally a disc but which may be any other form of optical format including magneto-optical, phase-change and dye recording. It is known that the minimum number of channel bits per mark is three for CD (EFM coding), also three for DVD (EFM+ coding) and two for blu-ray disk/SFFO (17-PP coding). In such cases, no one-bit marks are required. The leading edge corresponds to the beginning of the mark that represents the first bit and the trailing edge corresponds to the end of the last bit of the information represented by the mark. If one-bit marks are required, the leading edge corresponds to the beginning of the mark that represents the single bit and the trailing edge corresponds to the end of said bit.

FIG. 3 shows a first embodiment of the invention applied to the conventional pulse pattern proposed in FIG. 1. The invention aims at reducing the average laser current in time in order to reduce the power dissipation in the writer. In the prior art, the average laser current is necessarily higher than the threshold current as the laser current is always higher than this threshold current. A large power dissipation thus occurs. A way to reduce the average current is to pulse the laser during writing by switching it off periodically. During the time the laser is switched off, the laser current is near zero or equal to zero. Correct marks can be obtained by switching off the laser with a frequency that causes pulses of the first pulse pattern to be divided into several shorter pulses that rise from zero to at least a high laser current write level IHWL. It is possible to reduce the average laser current in this manner. The invention thus proposes to switch the laser, for example according to a given frequency called writing frequency, during the writing of a recorded mark MK.

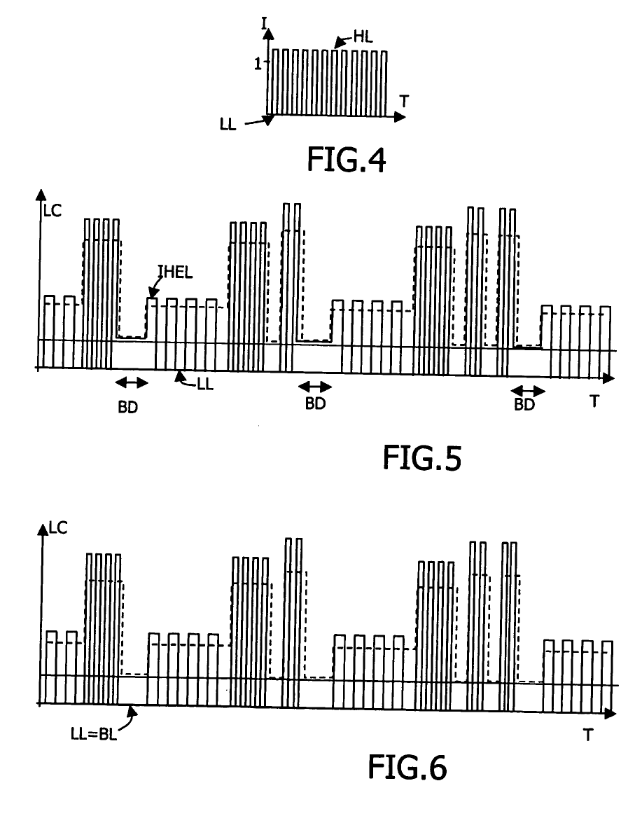

In FIG. 3, the conventional pulse pattern is represented by a broken line while a writing strategy according to the invention is represented by a plain line. The writing strategy according to the invention is then advantageously obtained through multiplication of the conventional pulse pattern by a second pulse pattern having a given frequency, for example a constant one. Said multiplication is advantageously realized only during pulses at the high write level HWL of the conventional strategy as shown in FIG. 3, and not during bias level periods of said conventional strategy. According to the invention, it is necessary that the writing frequency of the multiplied second pulse pattern is higher than the maximum frequency at which level changes occur in a conventional strategy as illustrated in FIG. 1. The frequency of this second pulse pattern is frequency and phase locked to the conventionally used clock or a multiple of said clock. The start of a write level in the conventional strategy should coincide with a rising edge in the newly obtained pulse pattern. One may have to tune the timing of the first laser current pulse of the write strategy according to the invention such that the rising edge of the light output of the first pulse coincides with the rising edge of the light output of the first pulse in the conventional strategy. The second pulse pattern is illustrated in FIG. 4 and is thus such that the pulses are raised from a low level LL to a high level HL. The high and low levels correspond to respective laser current intensities. The frequency is represented as a constant frequency, but the invention may use any other second pulse pattern by which a conventional pattern can be multiplied in order to have pulses raised from a low level close or equal to zero to a high level, said pulses having a more frequent occurrence than in conventional strategy pulse pattern. Any sequence of pulses allowing this latter feature is allowed according to the invention.

The second pulse pattern multiplied by the conventional pulse pattern should have a high level HL higher than 1 in order that a same average delta current is obtained during the time a mark is being written. Effectively, if the same average delta current is obtained, the same average light power is also obtained during the writing of a mark. Thus a correct mark is obtained on the optical medium. The low level LL of the multiplied second pulse pattern may be zero current, as shown in FIG. 4, or a relatively small current of the order of a few mA. Such a low level LL reduces the threshold current savings somewhat, but it also reduces the rise time of the laser current. This is important as a shorter rise time can reduce jitter. A high laser current write level IHWL is then obtained. This high write level IHWL of the obtained new pulse pattern after multiplication is then higher than the one HWL of the conventional pulse pattern.

A duty cycle D is defined as the fraction of time per pulse cycle of said multiplied second pulse pattern, as illustrated in FIG. 4, during which the laser is on. A duty cycle D of 25% would mean, for example, that the laser is on during 25% of the time in each cycle. D=50% appears to be an optimal duty cycle D. It means that the duration during which the laser is at the high laser current write level IHWL is the same as the duration during which the laser is at the low level. Said duty cycle may nevertheless be chosen to be different. Effectively smaller duty cycles provide more power savings, but they may lead to increased jitter.

Thus, the achievable power reduction is dependent on the duty cycle, on the threshold current, on the low level, and on the losses in the internal capacitance associated with the laser caused by the switching. The average light power reaching the optical medium is assumed to be the same. This is not a necessary assumption. This assumption means that, if pulses with a duty cycle of 50% are realized, the delta current should be twice as high, resulting in the same average light power being emitted. Pulsing the laser according to the invention achieves a saving in threshold current. The amount of threshold power that is saved when pulsing with a low level LL of zero is (1-D) times the threshold power.

Thus, if a conventional pulse pattern is used and a duty cycle D is applied to the second multipled pulse pattern, the power P saving is expressed by:
ΔP=P_{laser,continuous}−P_{laser,pulsed}

As was explained above, what is saved is a fraction (1-D) of (P_{threshold}−P_{low}) with P_{low} being the low level LL of the pulses during pulsing and P_{threshold} the threshold level. It is also to be noted that pulsing the laser also costs some additional power P_{cap,laser} because an internal capacitance in the laser needs to be charged and discharged more often. It represents the creation and destruction of population inversion. This charging and discharging does not contribute to the light power being emitted and is just lost. So to calculate the real saving this P_{cap,laser} has to be subtracted from the power savings as calculated above. Hence, the power saving is indicatively expressed by:
ΔP=(1-D).(P_{threshold}−P_{low})−P_{cap,laser}.

It is possible to reduce the capacitive losses in the laser by choosing a resonant laser driver. Effectively such capacitive losses are a drawback for pulse patterns obtained according to the invention as the laser is switched off while they are less of a problem for the conventional pulse pattern, where the laser pulses are raised from the bias level close to the threshold level.

A minimum duty cycle of 50% is allowed without any jitter increasing. According to a most preferred embodiment of the invention, the duty cycle is thus D=50%, especially for erasing.

An additional advantage of the invention is that jitter and crosswrite may be reduced and DOW cyclability increased.

FIG. 5 shows an advantageous embodiment of the invention wherein irradiation means are pulsed at an erasing frequency to a high laser current erase level IHEL from a low level LL close or equal to zero during erasing of a recorded mark. The erasing frequency is represented in FIG. 5 as being lower than said writing frequency. This erasing frequency may be different, higher or lower than, or equal to said writing frequency. The new erase pulse pattern is obtained by a multiplication of the conventional erase pulse pattern, that is conventionally a single continuous pulse, by a second pulse pattern of a constant frequency, rising above a low level LL to a high level HL that is preferably slightly higher than 1, as is shown in FIG. 4. This second pulse pattern has to be frequency and phase locked to the conventionally used clock or to be a multiple of it. Said second pulse pattern may also be any pulse pattern by which a conventional pattern can be multiplied in order to have pulses raised from a low level close or equal to zero to a high level, said pulses having a more frequent occurrence than in conventional strategy pulse pattern. Again the start of the rise of an erase level in the conventional strategy should coincide with a rising edge in the newly obtained pulse pattern. Said bias level BL may also be multiplied by a second pulse pattern as presented in FIG. 4. In this case, pulses of a constant bias frequency appear in FIG. 5 also during the period BD illustrated by an arrow in said FIG. 5.

FIG. 6 depicts a preferred embodiment of the invention. According to this preferred embodiment, the bias level BL is equal to the low level LL in order to further reduce the power dissipation.

It is to be noted that a reduction of the average laser current can help reduce the problem of cross-write that occurs when some light falls on a neighboring track, thereby deteriorating the marks/spaces already written in that neighboring track. This may also lead to lower overall jitter, which is the amount of deviation from the intended position of the mark edges or boundaries. So the information storage/record is of better quality. The invention can also increase the Direct Over Write cyclability, which is the number of times a re-writable optical medium can be written and erased.

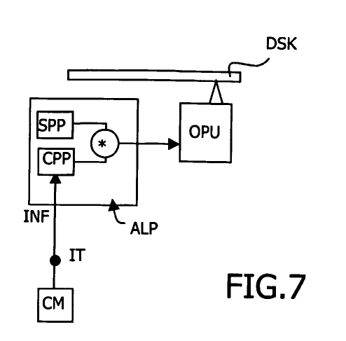

FIG. 7 is a schematic diagram of a recording apparatus of the invention. In this apparatus, an optical medium, for example a disc DSK, is positioned so as to face an optical pickup unit OPU. Information INF to be recorded on said disc DSK is provided by an input terminal IT to an automatic laser power controlling mechanism ALP. Said information INF is considered have been coded previously by a coding module CM placed before said input terminal. Said mechanism ALP controls the power of the laser light emitted from the optical pickup unit OPU. Thus said mechanism ALP provides a laser diode circuit with a signal that will control the laser current provided to said laser diode. Said signals depend on the inputted information INF. Thus, according to the invention, said signals achieve that the laser current is pulsed and consequently that laser light is emitted from the optical pickup unit OPU. For example, according to the first embodiment of the invention illustrated by FIG. 3, signals formed within said mechanism ALP are the multiplication, during each writing action, of a conventional pulse pattern CPP known for the writing of binary values present in inputted information INF (at least two or three bits, as discussed above) by a second pulse pattern SPP as shown in FIG. 4.

The figures shown are illustrative of special embodiments of the invention and are not restrictive. Effectively, the invention may, for example, be implemented by multiplying a second pulse pattern as described hereinabove in FIG. 4 by any style of pulse pattern allowing the writing of a mark. In a simple example, the conventional pulse pattern is not pulsed with N-1 pulses but is simply constituted of a rise to a high level followed by a drop to a low level. It will be apparent to those skilled in the art that many modifications and variations may be made to the exemplary embodiments of the present invention set forth above, without departing substantially from the principles of the present invention. For example, the present invention may be used with any optical record carrier of any format. All such modifications and variations are intended to be included herein.

1. An information recording apparatus designed for recording information on an optical medium, wherein irradiation means emitting a light beam form series of recorded marks whose lengths between leading edge and trailing edge correspond to respective binary values, characterized in that said irradiation means are sequentially pulsed to at least a high laser current write level from a low laser current level LL close to zero during the writing of a recorded mark.

2. An information recording apparatus as claimed in claim 1, wherein said low laser current level LL is equal to zero.

3. An information recording apparatus as claimed in claim 1, wherein said irradiation means are sequentially pulsed to a high laser current erase level from said low laser current level close to zero during the erasing of a recorded mark.

4. An information recording apparatus as claimed in claim 1, wherein a bias level is reached during time intervals different from writing and/or erasing time intervals, and wherein said bias laser current level is substantially equal to said low laser current level.

5. An information recording method for recording information on an optical medium by forming with a light beam emitted from irradiation means, series of recorded marks whose lengths between leading edge and trailing edge correspond to respective binary values by irradiation means with a beam of light, characterized in that it comprises a step of sequentially pulsing said irradiation means to a high laser current write level from a low laser current level LL close to zero during the writing of a recorded mark.

6. An information recording method as claimed in claim 5, wherein said low laser current level LL is equal to zero.

7. An information recording method as claimed in claim 5, wherein it comprises a step of pulsing said irradiation means to a high laser current erase level from said low laser current level close to zero during the erasing of a recorded mark.

8. An information recording method as claimed in claim 5, wherein a bias level is reached during time intervals different from writing and/or erasing time intervals, and wherein said bias laser current level is substantially equal to said low laser current level.
